(19) United States
(12) Patent Application Publication
(10) Pub. No.: US 2026/0278559 A1
(43) Pub. Date: Sep. 17, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Tooru IWAMOTO, Toyota (JP)

(73) Assignee: NEC Corporation, Tokyo (JP)

(21) Appl. No.: 19/557,410

(22) Filed: Mar. 5, 2026

(30) Foreign Application Priority Data
Mar. 17, 2025 (JP) 2025-042729

(51) Int. Cl. G06Q 10/1093; G01C 21/34

(52) U.S. Cl. CPC G06Q 10/1093; G01C 21/3407

(57) ABSTRACT

An information processing apparatus according to the present disclosure includes at least one memory storing instructions; and at least one processor configured to execute the instructions to: receive pieces of information of a plurality of individuals; generate, based on pieces of the information of the plurality of individuals received, a group organization plan using a machine learning model with at least one of age balance, personality compatibility, a movement distance, avoidance of a dangerous spot, a meeting time, and an ability as a constraint condition; and output the group organization plan generated. This apparatus leverages AI-based machine learning to enable reliable and efficient decision making in group formation.

This application is based upon and claims the benefit of priority from Japanese patent application No. 2025-042729, filed on Mar. 17, 2025, the disclosure of which is incorporated herein in its entirety by reference.

### TECHNICAL FIELD

The present disclosure relates to an information processing apparatus and the like configured to support group formation.

### BACKGROUND ART

Mainly in elementary schools, children come to and from school together in a group along a school road. Such a group is called a walking school bus, and is organized by a local community association or the like. The organization of the walking school bus depends on discretion of district officer, and it is necessary to consider troubles between families, personalities of children, school grades, dangerous routes, a meeting time, and the like. The organization relies on intuitions and experience of the district officer and limited information. JP 2010-113547 A discloses a school-commuting range optimization device that arranges a child to a school district that is optimal, highly convenient, and safe based on a school-commuting distance and information related to the child. In JP 2010-113547 A, children living in the same block are set to the same school.

### SUMMARY

An object of the present disclosure is to provide an information processing apparatus and the like capable of reducing a burden on an administrator in charge of group formation.

An information processing apparatus according to an aspect of the present disclosure includes at least one memory storing instructions; and at least one processor configured to execute the instructions to: receive pieces of information of a plurality of individuals; generate, based on pieces of the information of the plurality of individuals received, a group organization plan using a machine learning model with at least one of age balance, personality compatibility, a movement distance, avoidance of a dangerous spot, a meeting time, and an ability as a constraint condition; and output the group organization plan generated.

An information processing method according to an aspect of the present disclosure includes receiving pieces of information of a plurality of individuals, generating, based on pieces of the information of the plurality of individuals, a group organization plan using a machine learning model with at least one of age balance, personality compatibility, a movement distance, avoidance of a dangerous spot, a meeting time, and an ability as a constraint condition, and outputting the generated group organization plan.

A non-transitory computer-readable recording medium according to an aspect of the present disclosure stores a program that causes a computer to execute processing of receiving pieces of information of a plurality of individuals, generating, based on pieces of the information of the plurality of individuals, a group organization plan using a machine learning model with at least one of age balance, personality compatibility, a movement distance, avoidance of a dangerous spot, a meeting time, and an ability as a constraint condition, and outputting the generated group organization plan.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of an information processing apparatus according to the present disclosure;

FIG. 2 is a flowchart illustrating an operation example of the information processing apparatus according to the present disclosure;

FIG. 3 is a block diagram illustrating a configuration example of an information processing apparatus according to the present disclosure;

FIG. 4 is a flowchart illustrating an operation example of the information processing apparatus according to the present disclosure;

FIG. 5 is a block diagram illustrating a configuration example of an information processing apparatus according to the present disclosure;

FIG. 6 is a flowchart illustrating an operation example of the information processing apparatus according to the present disclosure;

FIG. 7 is a block diagram illustrating a configuration example of an information processing apparatus according to the present disclosure;

FIG. 8 is a flowchart illustrating an operation example of the information processing apparatus according to the present disclosure;

FIG. 9 is a block diagram illustrating a configuration example of an information processing apparatus according to the present disclosure;

FIG. 10 is a flowchart illustrating an operation example of the information processing apparatus according to the present disclosure;

FIG. 11 is a block diagram illustrating a configuration example of an information processing apparatus according to the present disclosure;

FIG. 12 is a flowchart illustrating an operation example of the information processing apparatus according to the present disclosure;

FIG. 13 is a block diagram illustrating a configuration example of an information processing apparatus according to the present disclosure;

FIG. 14 is a flowchart illustrating an operation example of the information processing apparatus according to the present disclosure; and

FIG. 15 is a diagram illustrating an example of a hardware configuration of the information processing apparatus according to the present disclosure.

### EXAMPLE EMBODIMENT

### First Example Embodiment

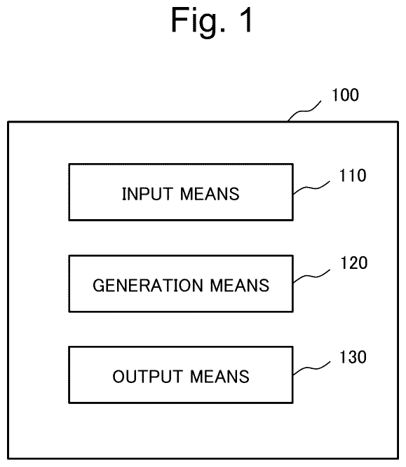

In the following description, an example will be described in which an information processing apparatus according to the present disclosure is applied to support walking school bus organization of elementary school students. Hereinafter, a configuration example of an information processing apparatus 100 according to a first example embodiment will be described with reference to FIG. 1. In the drawing, the information processing apparatus 100 includes an input means 110, a generation means 120, and an output means 130.

The input means 110 receives pieces of information of a plurality of individuals. Specifically, the input means 110 has a function of receiving input of personal information (grades, addresses, personality characteristics, and the like) of children through a web interface, for example. An administrator of a school or an area can enter information via a web browser.

The generation means 120 has a function of generating a group organization plan using a machine learning model based on pieces of the information of the individuals received by the input means 110. The generation means 120 considers at least one of age balance, personality compatibility, a movement distance, avoidance of dangerous spots, a meeting time, and an ability as a constraint condition. A neural network or the like is used as an example of the machine learning model. The group organization plan represents constituent members of each group. In particular, in the present example embodiment, the group organization plan represents each group of children constituting each walking school bus. The generation means 120 may further select a meeting point, a meeting time, and a recommended route of the group using the machine learning model. At this time, the generation means 120 considers at least one of ages, personalities, movement distances, avoidance of dangerous spots, meeting times, and abilities of individuals as the constraint condition.

Specifically, the generation means 120 generates a walking school bus organization plan. The generation means 120 considers the constraint condition as follows, for example.
Age balance: Arrange a first-grade child to a sixth-grade child in each group in a well-balanced manner. For example, if each group includes six persons, arrange one person per grade. Furthermore, for example, set a sixth-grade child as a team leader, and assign a helper role in combination with a first-grade child.
Personality compatibility: Combine an active child and a calm child. Furthermore, give consideration in such a way that children having a history of bullying between them do not belong to the same group.
Movement distance: Optimize a movement distance of the entire group while minimizing a distance from home of each child to a meeting point. Furthermore, for example, gather children living within a radius of 500 m into the same group.
Avoidance of dangerous spots: Select a route to avoid, as much as possible, a road with a large traffic volume, a place where an accident occurred in the past, and an area where a suspicious person frequently appeared in the past. Furthermore, adjust constituent members and a meeting point in such a way as to avoid dangerous spots as much as possible. Information on the suspicious person is provided from, for example, the police.
Meeting time: In consideration of the time required from home of each child to a meeting point, adjust constituent members, the meeting point, and a meeting time in such a way that all the members can meet at the designated time.

The output means 130 has a function of displaying the walking school bus organization plan generated by the generation means 120 on an administrator screen. Specifically, the walking school bus organization plan is displayed together with detailed information such as constituent members of each group, a meeting point, the meeting time, and a recommended route.

The administrator can confirm the proposed content and make a manual adjustment if necessary. For example, if a route proposed by a system does not match the actual situation of the area, the administrator can modify a route through the interface. Furthermore, it is also possible to move a specific child to a different group or change a meeting time.

In one example, the generation means 120 has a school road safety evaluation function. The school road safety evaluation function is a function of analyzing past accident data and traffic volume information, calculating a safety score of each route, and preferentially proposing the safest route.

In this example, for example, the generation means 120 mainly applies “avoidance of dangerous spots” as the constraint condition. Specifically, a risk score is assigned to each road section based on past accident data and crime statistics, and a route that minimizes the overall risk level is selected. Furthermore, the balance between safety and efficiency is taken by considering the traffic volume, the presence or absence of a crosswalk, and the like. For example, a safety score of each road section is represented by a numerical value from 0 to 100 using traffic accident data for the past 5 years and traffic volume data for each time slot. Then, only a route with a safety score equal to or more than 80 is used, and the route with the highest overall safety is selected. Furthermore, for example, a risk score is assigned to each road section based on past accident data and crime statistics, and a route that minimizes the overall risk level is selected. For example, a risk score of 80 is assigned to an intersection where the number of accidents that occurred in the past 3 years is equal to or more than 2, and a route bypassing the intersection as much as possible is proposed.

As described above, according to the school road safety evaluation function, the information processing apparatus 100 can automatically perform efficient walking school bus organization while giving top priority to the safety of children. This makes it possible to achieve safer and more efficient school-commuting while greatly reducing a burden on a district officer.

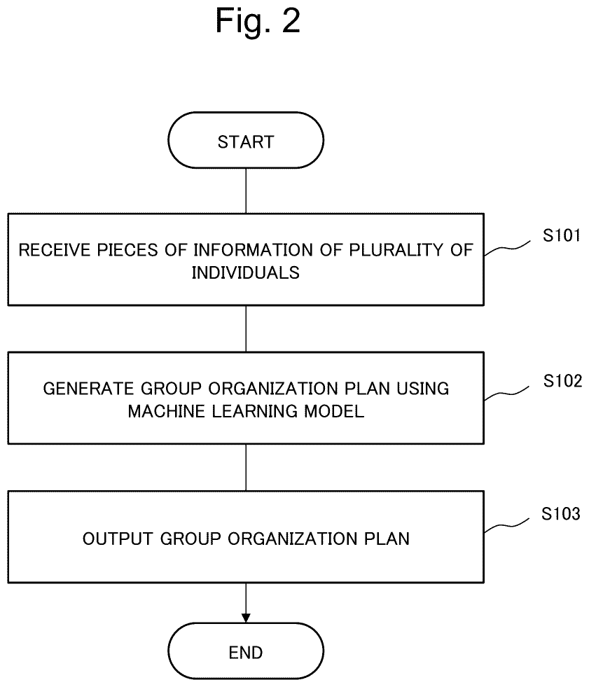

Next, an operation example of the information processing apparatus 100 will be described with reference to FIG. 2. FIG. 2 is a flowchart illustrating a procedure of processing performed by the information processing apparatus 100.

First, the input means 110 receives personal information of children through the web interface (step S101). Specifically, the administrator of the school or the area inputs information such as grades, addresses, and personality characteristics of the children through the web browser.

Next, the generation means 120 generates an optimal walking school bus organization plan using the machine learning model based on the information received by the input means 110 (step S102). At this time, the generation means 120 generates an organization plan in consideration of age balance, personality compatibility, movement distances, and the like. Furthermore, the school road safety evaluation function of the generation means 120 analyzes past accident data and traffic volume information and calculates a safety score of each route. Then, the generation means 120 creates an organization plan that preferentially proposes the safest route in consideration of the calculated safety scores.

Finally, the output means 130 displays the generated organization plan and a recommended route on the administrator screen (step S103). The displayed information includes constituent members of each group, a meeting point, the meeting time, a map of the recommended route, and the like.

It is necessary to perform group formation such as organization of a school-commuting group and formation of a group in consideration of various information. However, there is a problem that a burden on an administrator in charge of group formation is great because the administrator relies on his/her intuition and experience and limited information.

With the information processing apparatus 100 according to the present example embodiment, efficient walking school bus organization can be automatically performed while considering the safety of children. This makes it possible to significantly reduce the burden on the district officer as compared with creation of a walking school bus by a manual operation. Specifically, it is possible to greatly reduce the time and labor required for organizing the walking school bus and determining a school route.

Further, the information processing apparatus 100 analyzes various types of data and proposes an optimal school road while flexibly responding to a change in situation. This makes it possible to select a school road based on more objective and comprehensive safety evaluation as compared with a related method that relies on human experience and intuition. As a result, the safety of children during school-commuting can be improved. Furthermore, it is difficult to make an objective and fair determination in the creation of the walking school bus by the manual operation, and dissatisfaction with group organization and a meeting time after the determination is sometimes directed to the district officer. According to the present example embodiment, since the determination is made based on various types of data and objective criteria, the determined group organization and meeting time are easily accepted more neutrally. This can reduce a mental burden on the district officer and also contribute to maintaining personal relationships within the community.

The information processing apparatus 100 of the present disclosure further has the following functions, and thus can achieve more flexible and effective school-commuting group organization.

Instead of the web interface which is an example of the input means 110, a dedicated mobile application may be used. In this case, a guardian or a teacher can directly input information of a child through a smartphone or a tablet terminal, so that more detailed and real-time information can be collected.

The input means 110 can receive the height of a child as personal information of the child. The generation means 120 recalculates a walking speed according to a change in the height. The input means 110 can receive a health condition and special needs (e.g.: use of a wheelchair, allergy information, and the like) of the child. The generation means 120 performs group organization in consideration of these pieces of information. For example, in a group including a child with a severe allergy, consideration is given to arranging a child who can take a measure in an emergency in the same group.

In addition to or instead of the “meeting time” and the “age balance” used as the constraint conditions, “sibling relationship”, “proximity of residence”, and the like may be used. For example, by organizing siblings into the same group or grouping children living in the neighborhood, more efficient group organization can be performed.

The group organization may be periodically (for example, weekly or monthly) changed by the generation means 120. This enables periodic optimization while maintaining stability of the system. Furthermore, the generation means 120 may cope with a school event. In a case where home time is changed due to a school event, such as a period before and after a field day or a school trip, when an event schedule is input, special group organization limited to such a period is proposed. For example, the group organization is proposed in consideration of the home time of each grade.

The generation means 120 can propose a route in consideration of activity information of school safety volunteers in the area, position information of Kodomo-Hyakutoban-no-ie (a kind of children's emergency shelter in Japan), and the like. By utilizing these pieces of information, the generation means 120 can design a route with higher safety and perform group organization in consideration of places where the school safety volunteers are arranged.

The generation means 120 may generate an alternative route in consideration of an evacuation route in an emergency or a disaster. For example, a route avoiding a building or bridge having a risk of collapse when an earthquake occurs, the shortest route to a hill when a tsunami warning is issued, a route passing through an area having a low risk of water immersion when a flood occurs due to heavy rain, and the like are generated. Furthermore, when suspicious person information is received, a route bypassing the related place is immediately calculated. Each alternative route is displayed, for example, with information such as a difference in required time as compared to a normal route, an assumed risk, and necessary preparations. Further, this system may also include a communication function in an emergency. For example, when suspicious person information or a sudden danger occurs, the system can immediately transmit an alert to all the persons concerned (children, guardians, teachers, school safety volunteers, and the like) and instruct evacuation to a safe place or immediate change of group organization.

Furthermore, a support vector machine or a decision tree algorithm may be used instead of the neural network which is an example of the machine learning model in the generation means 120. Further, when ensemble learning in which a plurality of machine learning models are combined is adopted, it is possible to generate a more accurate walking school bus organization plan.

The generation means 120 may generate a group organization plan using generative artificial intelligence (AI). Specifically, the generation means 120 inputs a prompt including information of children and a constraint condition to a language model such as a large language model (LLM), and outputs a walking school bus organization plan. As an advantage of using the generative AI, since input in a natural language is possible, a complicated constraint condition and a special case can also be easily reflected. Furthermore, the reason and basis of the organization plan can be described in a natural language, and explanation to the administrator and guardians becomes easy.

Furthermore, the generation means 120 may generate a group organization plan using a machine learning model and generate a recommended route using an existing route search algorithm.

The generation means 120 may generate an optimal group organization plan that simultaneously satisfies a plurality of constraint conditions. However, in a case where there are too many constraint conditions or in a case where a contradiction occurs between the conditions, there is a possibility that it is difficult to find an optimal solution. For example, there is a case where too much emphasis on the age balance sacrifices the optimization of the movement distance. In this case, the generation means 120 may weight the respective constraint conditions and set the priority order to generate a sub-optimal solution. For example, the highest weight is given to a constraint related to the safety (avoidance of dangerous spots), and then the weights are set in the order of the age balance and the movement distance. As a result, a solution satisfying the conditions in descending order of importance can be obtained even if all the conditions cannot be completely satisfied.

The output means 130 may be configured to provide a dedicated mobile application for guardians and/or children instead of the administrator screen as an example, and display the organization plan and the school route on the application. In this case, information can be confirmed in real time at each home, and thus, the information can be shared more quickly.

Instead of or in addition to the display on the administrator screen by the output means 130, the organization plan may be notified to a person concerned using an electronic mail, a short message service (SMS), a push notification, or the like. Furthermore, a new group organization plan may be automatically posted in cooperation with an electronic bulletin board system of the school. This makes it possible to receive important information in real time even if the administrator does not always access the system. Furthermore, the output means 130 may change a notification method in accordance with the degree of urgency. For an important change with a high degree of urgency, the push notification or the SMS is used. For example, a change in the meeting time or the meeting point has a high degree of urgency.

Instead of the display on the administrator screen, the output means 130 may adopt a method of transmitting an automatically generated PDF report by e-mail to a person concerned. This facilitates sharing and storage of information.

Further, the output means 130 may use a speech synthesis system instead of the function of displaying on the administrator screen as an example. In this case, the generated organization plan and route information can be output by voice to enable information transmission to a visually impaired administrator and information transmission under a situation where the screen cannot be viewed.

Further, the output means 130 may present a plurality of generated sub-optimal solutions to the administrator, and entrust the final selection to the administrator. At this time, features (e.g.: emphasis on safety, emphasis on distance optimization, and the like) of the respective solutions are displayed in an easy-to-understand manner, and support is provided in such a way that the administrator can select an appropriate solution in accordance with the actual situation of the area.

Instead of the consideration of past accident data and traffic volume information as an example of the school road safety evaluation function, more detailed environmental factors such as installation conditions of security cameras and brightness of street lamps may be considered. Furthermore, by incorporating information provision from local residents, it is possible to perform safety evaluation more adapted to the actual situation of the area.

Furthermore, the generation means 120 may be configured to analyze information collected from social media such as a social networking service (SNS), instead of official information from the police, and more quickly grasp a situation change. However, in this case, it is necessary to perform appropriate filtering while paying attention to false information and the like. The generation means 120 may further have a function of receiving emergency reports from users. A dangerous spot can be immediately registered based on these reports, and a route can be recalculated. For example, it is conceivable to construct a system in which a guardian and a local resident can report eyewitness information regarding a suspicious person and a dangerous situation through a smartphone application to immediately reflect these pieces of information. With these functions, the information processing apparatus of the present example embodiment functions as a more comprehensive and flexible school-commuting support system, and can ensure the safety of children from multiple viewpoints. At the same time, it is possible to contribute to both reinforcement of a watching system in the entire local society and improvement of safety of the community.

The information processing apparatus 100 may be provided as a cloud-based service. As a result, a common platform can be used by a plurality of schools and areas, and introduction and operation costs can be reduced.

### Second Example Embodiment

In the following description, an example will be described in which an information processing apparatus according to the present disclosure is applied to support organization of a walking school bus of elementary school students accompanied by guardians. In the second example embodiment, schedules of the guardians are considered.

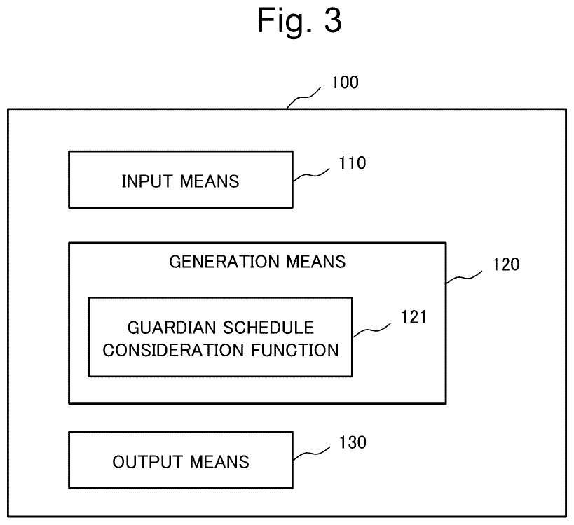

A functional configuration example of the information processing apparatus 100 according to the second example embodiment will be described with reference to FIG. 3. In the drawing, the information processing apparatus 100 includes an input means 110, a generation means 120, and an output means 130. In the configuration of the second example embodiment, the description of the same configuration as that of the first example embodiment will be partially omitted.

The input means 110 receives information of a plurality of individuals through a web interface. Specifically, personal information (grade, address, personality characteristics, and the like) of each child and schedule information of each guardian are input. The schedule information indicates the possibility of being accompanied by the guardian. The schedule information may include a working hour and work place information of the guardian to derive days of the week and time when the guardian can join as a companion.

The generation means 120 generates an optimal walking school bus organization plan based on pieces of the information of the individuals received by the input means 110 using a machine learning model. The generation means 120 uses at least one of age balance, personality compatibility, a movement distance, avoidance of a dangerous spot, a meeting time, and an ability as a constraint condition.

The generation means 120 has a guardian schedule consideration function 121. The guardian schedule consideration function 121 generates a walking school bus organization plan in consideration of whether each guardian can help school-commuting. For example, the generation means 120 generates groups of children and assigns guardians who can accompany the groups, respectively.

Furthermore, the generation means 120 may group children based on whether the guardian can help school-commuting. Specifically, for example, whether each guardian can help school-commuting is evaluated by the following procedure and reflected in group organization:
1) A working time slot of each guardian on weekdays is acquired, and collated with a time for school and a time for home.
2) The time required for helping school-commuting is calculated from a positional relationship among a work place, a school, and home.
3) Pieces of information of 1 and 2 are combined to identify a day when each guardian can help school-commuting.
4) A group centered on the guardians who can help school-commuting is formed, and children in families having difficulty in helping school-commuting are appropriately arranged in the group.

For example, in a case where person A works at a company on Tuesday and Thursday while working at home on Monday, Wednesday, and Friday, it is determined that it is possible to help school-commuting on Monday, Wednesday, and Friday, and a child having a guardian who can help school-commuting on Tuesday and Thursday is assigned to a group including a child of the person A. As a result, a burden of helping school-commuting can be dispersed among the guardians.

Furthermore, the guardian schedule consideration function 121 also copes with a periodic schedule update. For example, when a work form of the guardian is changed by the input means 110, the group organization is re-optimized if necessary.

Further, it is also possible to cope with a sudden schedule change. For example, when a certain guardian cannot help school-commuting due to a sudden business trip, a system immediately generates an alternative plan. Specifically, a measure is taken by the following procedure:

Whether the other guardians of a relevant group can held school-commuting is reconfirmed.

When a guardian who can help school-commuting is found, a person in charge of helping school-commuting is temporarily changed.

When there is no appropriate alternative, integration or reorganization with a neighboring group is proposed.

All relevant guardians are notified of the changed content.

In one example, the guardian schedule consideration function 121 analyzes pieces of working hour information of guardians and calculates a meeting time at which the largest number of guardians are available. As a result, the same meeting time can be adopted every day even in a case where a plurality of guardians having different available times alternately join as a companion. At this time, the meeting time may be applied if necessary as a constraint condition. For example, a meeting time having a predetermined time width is applied.

The output means 130 displays the group organization plan generated by the generation means 120 on an administrator screen. Specifically, for example, the generated organization plan and the optimal meeting time are displayed.

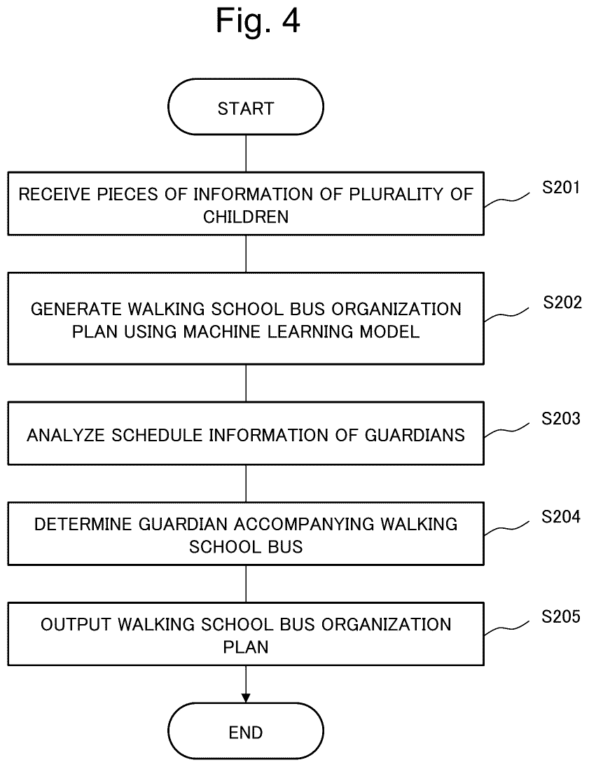

FIG. 4 is a flowchart illustrating an operation example of the information processing apparatus 100. Hereinafter, the operation example of the information processing apparatus 100 will be described in detail with reference to FIG. 4.

First, the input means 110 receives personal information of children and schedule information of guardians through the web interface (step S201). Specifically, for example, the personal information such as names, grades, addresses, and personality characteristics of the children, and the schedule information such as working hours and day-off information of the guardians are input.

Next, the generation means 120 generates a walking school bus organization plan using the machine learning model based on the received information (step S202). At this time, the generation means 120 creates the organization plan of the optimal groups of children in consideration of, for example, age balance, personality compatibility, movement distances, and the like.

Subsequently, the guardian schedule consideration function 121 of the generation means 120 analyzes the schedule information of the guardians (step S203). Specifically, for example, a work start time and a work pattern of each of the guardians are analyzed to identify whether the guardian can help school-commuting.

The generation means 120 determines a guardian accompanying each of the groups of children generated in step S202 based on the analysis result (step S204). At this time, the generation means 120 may calculate a meeting time at which the largest number of guardians are available. Furthermore, consideration according to age is also given, for example, by setting a later meeting time for a group including children in lower grades.

Finally, the output means 130 displays the generated organization plan and the optimal meeting time on the administrator screen (step S205). The displayed information includes constituent members of each group, a meeting point, the meeting time, a recommended route, and the like. In one example, information indicating guardians accompanying children constituting a walking school bus is displayed.

Further, the generation means 120 can change the meeting time and group organization in accordance with a change in a work shift of a guardian. For example, when the guardian has to work in the early morning suddenly, the system automatically receives input of such information and makes a proposal to temporarily move a relevant child to another group.

As described above, the information processing apparatus 100 can propose the optimal walking school bus organization and the optimal meeting time in consideration of the schedules of the guardians in detail. This makes it possible to significantly reduce a burden on a district officer and implement an efficient and safe school-commuting system that flexibly responds to situations of the guardians.

The information processing apparatus 100 can propose the optimal walking school bus organization and the optimal meeting time in consideration of the schedules of the guardians. As a result, the following effects can be obtained.

First, the burden on the district officer can be significantly reduced. The system automatically performs the organization of the walking school bus and the determination of the meeting time, which are manually performed by the district officer, thereby greatly reducing time and labor.

Next, a more efficient school-commuting system can be implemented. It is possible to reduce the burden on the guardians by analyzing the working hour information of the guardians and calculating the meeting time at which the largest number of guardians are available.

Further, it is possible to flexibly respond to the situations of the guardians. Since the meeting time and the group organization can be dynamically changed according to changes in the work shifts of the guardians or a school event, it is possible to quickly respond to a situation that changes every day.

In addition, it is possible to achieve both leadership training of upper-grade children and care for lower-grade children by the group organization in consideration of age balance. This makes it possible to ensure safety while promoting the growth of the children.

As described above, the information processing apparatus 100 can produce multifaceted effects such as the reduction of the burden on district officer, the implementation of the efficient and safe school-commuting system, the flexible response to the situations of the guardians, and the promotion of the growth of the children.

The generation means 120 according to the second example embodiment calculates the optimal meeting time based on the schedule information of the guardians. In a case where a work form of a guardian is irregular or frequently changed by a shift system, the initially input schedule information may not match the actual situation. In this case, the input means 110 can receive a schedule update in real time through a mobile application for guardians. When a work shift is changed, the guardian can immediately update the information through the app. The generation means 120 can recalculate a meeting time and group organization if necessary based on the updated information and propose a change plan.

This makes it possible to maintain the optimal meeting time in accordance with the actual working situations of the guardians, and it is possible to implement a more flexible and practical school-commuting system.

In one example, the generation means 120 performs group organization in consideration of age balance. When the number of children in a specific grade is extremely small, or when there is a child requiring special consideration, there is a case where appropriate group organization cannot be achieved only with simple age balance. In this case, the generation means 120 can perform weighting in consideration of individual characteristics and needs of children. For example, a high priority is set for a child requiring special consideration, and group organization suitable for the child is preferentially performed. Furthermore, in a case where variations among the grades are great, the group composition can be flexibly adjusted in accordance with the proportions of the grades.

This enables finer group organization based on not only simple age balance but also the characteristics of the individual children and the actual situation of a school.

Further, the generation means 120 changes the meeting time and the group organization in accordance with a change in a work shift of a guardian. Frequent changes can cause confusion for the children and the guardians. In this case, the generation means 120 can determine the necessity of a change based on a frequency of change and the degree of influence. For example, in the case of a minor change, the current organization is maintained, and a change is proposed only when there is a large influence. Furthermore, even when a change is necessary, a proposal can be made to avoid a sudden change and shift to new organization in stages.

This makes it possible to minimize a burden on the children and the guardians while maintaining the flexibility of the system.

The guardian schedule consideration function 121 may consider not only the working hour information of the guardians but also commuting hours, the housework hours, and the like. This makes it possible to calculate the meeting time more adapted to the actual situation.

### Third Example Embodiment

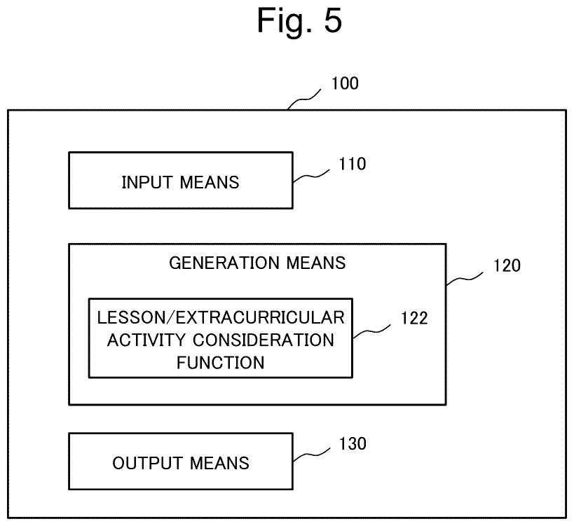

In the following description, an example will be described in which an information processing apparatus according to the present disclosure is applied to support of walking school bus organization in consideration of lessons and extracurricular activities of elementary school students. Hereinafter, the information processing apparatus 100 according to a third embodiment will be described with reference to FIG. 5.

FIG. 5 is a schematic block diagram illustrating a functional configuration example of the information processing apparatus. In the drawing, the information processing apparatus 100 includes an input means 110, a generation means 120, and an output means 130.

The input means 110 has a function of receiving input of lesson/extracurricular activity information in addition to grades, addresses, personality characteristics, and the like as personal information of children through a web interface. The extracurricular activity is, for example, a club activity or a committee activity. Specifically, an administrator of a school or a person in charge of an area can input information of each child via a dedicated web form.

The generation means 120 has a function of generating an optimal walking school bus organization plan based on the input information using a machine learning model. The generation means 120 particularly has a lesson/extracurricular activity consideration function 122.

The lesson/extracurricular activity consideration function 122 has a function of performing efficient group organization, for example, by analyzing schedules of lessons of children and grouping children attending the same lesson. For example, when children who go to the same private educational institute after school are organized into the same group, a movement at the time of coming home from school can be made more efficient.

The lesson/extracurricular activity consideration function 122 may have a function of considering schedules of lessons and extracurricular activities of individuals and flexibly changing a group organization plan based on the schedules. For example, a child who has a lesson in the evening of a weekday is excluded from a group for coming home from school together on the relevant day of the week and assigned to another group for coming home from school together. Furthermore, for example, on a day when there are a club activity and a committee activity, a special group for coming home from school together in which children participating in those activities are gathered is organized. In a case where a place of a lesson is located between home and school, a route passing through the place is set to enable an efficient movement.

The output means 130 has a function of displaying the generated organization plan on an administrator screen. Specifically, detailed information such as constituent members of each group, a meeting point, a meeting time, and a recommended route is displayed in a visually easy-to-understand manner.

Next, the operation of the information processing apparatus 100 will be described. First, the input means 110 receives personal information and lesson/extracurricular activity information of children. Next, the generation means 120 generates a walking school bus organization plan using the machine learning model based on the received information.

The lesson/extracurricular activity consideration function 122 of the generation means 120 analyzes schedules of lessons of the children. Specifically, pieces of information such as types, the days of the week, and time slots of the lessons of the children are extracted, and similarity and temporal proximity are evaluated. The generation means 120 performs efficient group organization by grouping children attending the same lesson based on the analysis result. For example, children who go to the same music class three times a week are organized into the same group, or children with close lesson time are gathered.

The lesson/extracurricular activity consideration function 122 of the generation means 120 may generate a special group for an extracurricular activity day based on schedules of extracurricular activities instead of or in addition to the schedules of the lessons. For example, a response is made by dividing groups between children with a club activity and children without any club activity or the like.

Finally, the output means 130 displays the generated optimal group organization plan on the administrator screen. The administrator can confirm this organization plan and make a manual adjustment if necessary.

The information processing apparatus 100 applies, for example, a “movement distance” and “personality compatibility” as main constraint conditions. Specifically, the total movement distance from home of each child to a meeting point is minimized while grouping children who go to the same lesson. Furthermore, compatible children are arranged in the same group using a personality diagnosis result.

For example, the generation means 120 comprehensively evaluates information such as a positional relationship between a place of a lesson and home, a time slot of the lesson, and personality characteristics of the child, and performs the optimal group organization. Specifically, for example, pieces of information such as types, the days of the week, and time slots of the lessons of the children are extracted, and similarity and temporal proximity are evaluated. The generation means 120 performs efficient group organization based on the analysis result. For example, the total movement distance from home of each child to a meeting point is minimized while grouping children who go to the same lesson. Furthermore, compatible children are arranged in the same group using a personality diagnosis result.

Further, the generation means 120 can change the group organization in accordance with a change in a schedule of a lesson or addition of a new extracurricular activity. For example, when a certain child enters a new sports club, the child is automatically rearranged to a group including children belonging to the same club.

Furthermore, the optimal group organization is proposed again in accordance with a change in a lesson per season (for example, from swimming class to English conversation class). Specifically, the generation means 120 checks an update of lesson information periodically (for example, once a month), and automatically generates a reorganization plan when there is a change.

As described above, the information processing apparatus 100 can achieve efficient group organization in consideration of the lessons and extracurricular activities of the children, and can flexibly respond to a change in a situation. This makes it possible to achieve safe and efficient school-commuting while supporting after-school activities of the children.

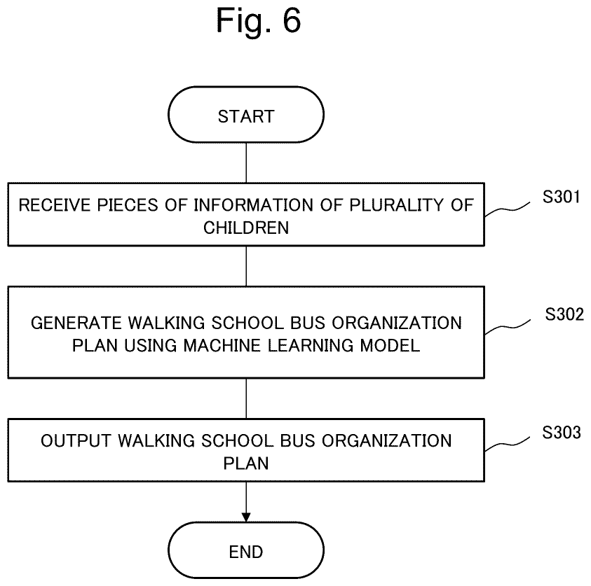

Next, the operation of the information processing apparatus 100 will be described in detail with reference to FIG. 6. FIG. 6 is a flowchart illustrating a procedure of processing performed by the information processing apparatus 100.

First, in step S301, the input means 110 receives personal information including lesson/extracurricular activity information of children. Specifically, the administrator of the school or the person in charge of the area inputs information such as a grade, an address, personality characteristics, a type, a day of the week, and a time slot of a lesson of each of the children via the dedicated web form.

Next, in step S302, the generation means 120 starts to generate a walking school bus organization plan based on the received information using the machine learning model.

Specifically, the generation means 120 comprehensively evaluates the following elements to perform group organization:
Basic Information (grades, addresses, personality characteristics, and the like) of children
Types, days, time slots, and places of lessons
Movement distances (distances from home to school and distances to places of lessons)
Personality compatibility
Age balance

Finally, in step S303, the output means 130 displays the generated optimal group organization plan on the administrator screen. The displayed information includes details such as constituent members of each group, a meeting point, a meeting time, and a recommended route.

The generation means 120 may identify a child having a high frequency of schedule change, and perform flexible group organization centered on the child. For example, a child whose schedule is frequently changed is treated as a “floating member”, and is assigned to an optimal group in accordance with a daily situation. This makes it possible to maintain efficient group formation as a whole while minimizing an influence of a schedule change of a specific child on group organization of the other children.

The generation means 120 can change the group organization in accordance with a change in a schedule of a lesson or addition of a new extracurricular activity. For example, when new lesson information or addition of an extracurricular activity is detected, the generation means 120 automatically generates a reorganization plan.

Furthermore, the generation means 120 can check an update of lesson information periodically (for example, once a month), and automatically generate a reorganization plan when there is a change. As a result, the optimal group organization can be always maintained in accordance with a change in a lesson per season (for example, from swimming class to English conversation class).

With the above operation, the information processing apparatus 100 can achieve efficient group organization in consideration of the lessons and extracurricular activities of the children, and can flexibly respond to a change in a situation. This makes it possible to achieve safe and efficient school-commuting while supporting after-school activities of the children.

According to the information processing apparatus 100, it is possible to achieve efficient group organization in consideration of the lessons and the extracurricular activities of the children. Specifically, the lesson/extracurricular activity consideration function 122 of the generation means 120 analyzes information such as the types, the days of the week, and the time slots of the lessons of the children, and groups children who go to the same lesson, so that a movement at the time of coming home from school can be made more efficient.

For example, when children who go to the same private educational institute after school are organized into the same group, they can move to the private educational institute together, and it is possible to reduce a burden on guardians helping school-commuting. Furthermore, when children with close lesson time are gathered, the waiting time at the time of coming home from school can be minimized.

Further, the information processing apparatus 100 can flexibly change the group organization in accordance with a change in a schedule of a lesson or addition of a new extracurricular activity. This makes it possible to quickly respond to a change in activity situations of the children and always maintain the optimal group organization.

With such efficient group organization, it is possible to achieve the safe and efficient school-commuting while supporting the after-school activities of the children. As a result, it is possible to simultaneously improve the quality of life of each of the children and reduce the burden on the guardians.

The generation means 120 can periodically check the update of the lesson information and receive a real-time information update from the guardians or teachers. Specifically, the guardians can immediately update the lesson information of the children through a dedicated mobile application.

Further, when a change in the lesson information is detected, the generation means 120 can immediately analyze an influence of the change on the group organization and readjust the group organization if necessary. At this time, the adjustment is performed within a minimum range of the influence in order to avoid large-scale reorganization.

Furthermore, in order to cope with a case where a sudden cancellation of a lesson or a temporary activity is generated, the generation means 120 can perform final confirmation in the morning of the day and make a temporary adjustment of group organization if necessary. This temporary adjustment can be immediately notified to the guardians and the children to minimize confusion.

With these measures, the information processing apparatus 100 can flexibly respond to fluctuations in information on lessons and extracurricular activities, and can always maintain the optimal group organization. As a result, inefficiency caused by incompleteness of information and sudden changes can be minimized, and effective school-commuting support can be achieved.

The function of inputting a lesson schedule may be provided in a module that cooperates with an individual schedule management system, or a system that collects information in cooperation with an SNS or a messaging application. Furthermore, a system having a function of predicting a future schedule from a past pattern using AI may be used. According to such a configuration, the generation means 120 can perform efficient group organization even when the information on the lessons and the extracurricular activities is incomplete or inaccurate. For example, even in a case where lesson information of a certain child is not updated, the child can be arranged in an appropriate group.

The lesson/extracurricular activity consideration function 122 may use an algorithm that preferentially considers geographical closeness of types or places of activities instead of evaluating the similarity and temporal proximity of schedules. This enables efficient group organization from different viewpoints.

The generation means 120 may change the group organization in accordance with a specific trigger event (e.g.: start of a new term, before and after consecutive holidays) instead of the periodic schedule (for example, once a month). Thus, reorganization can be performed at more appropriate timing.

Furthermore, instead of minimizing the total movement distance, the generation means 120 may adopt an optimization criterion that minimizes variations in movement times of each group. Thus, there is a possibility that more fair group organization can be achieved. Further, the compatibility between children may be determined using behavior observation reports regarding the children created by teachers, instead of the personality diagnosis result. This makes it possible to perform group organization in consideration of a more realistic human relationship.

### Fourth Example Embodiment

The present example embodiment relates to an information processing apparatus for improving safety and efficiency of children on their way to and from school. In particular, it is characterized in that it has a function of dynamically adjusting a school route in accordance with a change of a season or weather. Hereinafter, a case where the present information processing apparatus is assumed to be used in an elementary school will be described as an example.

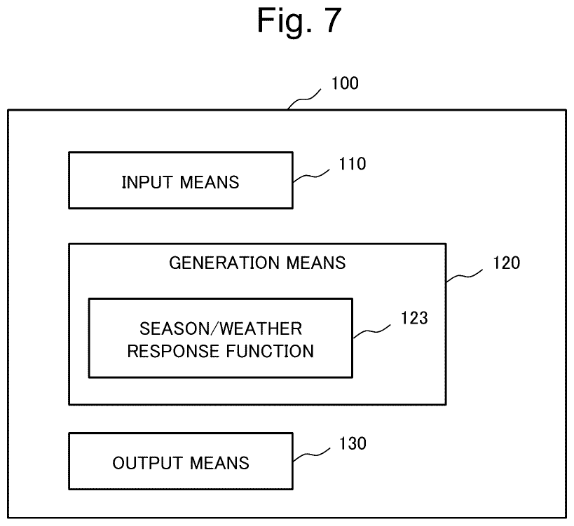

FIG. 7 is a block diagram illustrating a system configuration example of the information processing apparatus 100 in the present disclosure. The information processing apparatus 100 includes the input means 110, the generation means 120, and the output means 130. The generation means 120 includes a season/weather response function 123.

The input means 110 has a function of inputting weather data from a weather information application programming interface (API) in addition to a function of receiving input of personal information of children through a web interface. The generation means 120 generates an optimal walking school bus organization plan using a machine learning model based on the input information, analyzes current weather information using the season/weather response function 123 in cooperation with the weather information API, and proposes a safe alternative route if necessary. The output means 130 displays the generated organization plan and route on an administrator screen.

The operation of the present information processing apparatus will be described. First, the input means 110 receives personal information on children. Next, the generation means 120 generates a walking school bus organization plan using the machine learning model based on the received information. The input means 110 further inputs weather data from the weather information API. Thereafter, the season/weather response function 123 of the generation means 120 analyzes current weather information in cooperation with the weather information API. Based on the analysis result, the generation means 120 automatically proposes a safer alternative route when there is rain or snowfall. Finally, the output means 130 displays the generated organization plan and the optimal route based on the weather on the administrator screen.

The generation means 120 reduces the number of persons in a group from 6 persons in the normal state to 4 persons in consideration of a movement with an umbrella as a response for rainy weather. Furthermore, a passage with a roof or an arcade of a shopping street is preferentially selected to make a change to a route with a low risk of water immersion.

For example, an example in which a route is generated by applying “avoidance of dangerous spots” and a “movement distance” as main constraint conditions will be described. The generation means 120 selects a route with the minimum total movement distance while avoiding a place where a risk level changes depending on a season or weather (for example, a slope that is likely to freeze in winter). Furthermore, group organization is adjusted in accordance with a change in sunshine hours in such a way that the children can go to school in a bright time slot.

The generation means 120 can change a school route and a meeting time in accordance with a weather forecast or a seasonal change of a season. For example, when a typhoon is approaching, a change to a route that is hardly affected by strong wind is automatically made. The generation means 120 can propose group organization and a route different between summer and winter in consideration of a seasonal change in sunrise and sunset times. For example, in a period when the sun sets early in winter, a smaller-scale group for coming home from school is organized, and a route with many street lamps is preferentially selected. Further, when a heatstroke warning alert is issued, a change to a route with more shade is made to increase rest points.

The output means 130 has a function of displaying information not only on the administrator screen but also on a mobile application for guardians and/or children. In a case where there is a sudden change of weather or a change of a route, a notification is immediately transmitted to all the persons concerned. The notification includes a reason for the change, a new route map, notes, and the like. For example:
“Group A: Taro Yamada (first grade), Hanako Suzuki (second grade), Jiro Sato (third grade), and Sachiko Tanaka (fourth grade)
Meeting point: South entrance of ∘∘ park
Movement route: South entrance of ∘∘ park→∘∘ shopping street→Front gate of ∘∘ elementary school

Notes: An arcade at ∘∘ shopping street will be used due to rain.”

In this system, children, guardians, and teachers are main subjects. When the children start to go to school, the system confirms a current weather condition and proposes a safe route if necessary. The guardians can confirm current positions of the children and a selected route in real time. The teachers can grasp states of all the children coming to school in a list, and quickly respond to lateness and unexpected situations.

The system periodically receives weather data from an API of the Meteorological Agency. The received data includes temperature, precipitation, wind speed, the ultraviolet index, and the like. Furthermore, position information of each child is received from a dedicated GPS device, and the progress of the child on the way to and from school is tracked in real time. These pieces of data are transmitted and received in an encrypted manner, whereby privacy and security are secured.

As described above, according to the present example embodiment, it is possible to propose a safe school road flexibly responding to a change of a season or weather, and safety of children on their way to and from school is greatly improved. Furthermore, information is shared in real time, thereby enhancing the sense of relief of the guardians and the teachers. Further, long-term accumulation and analysis of weather data enables a more accurate route proposal and continuously improves the utility of the system.

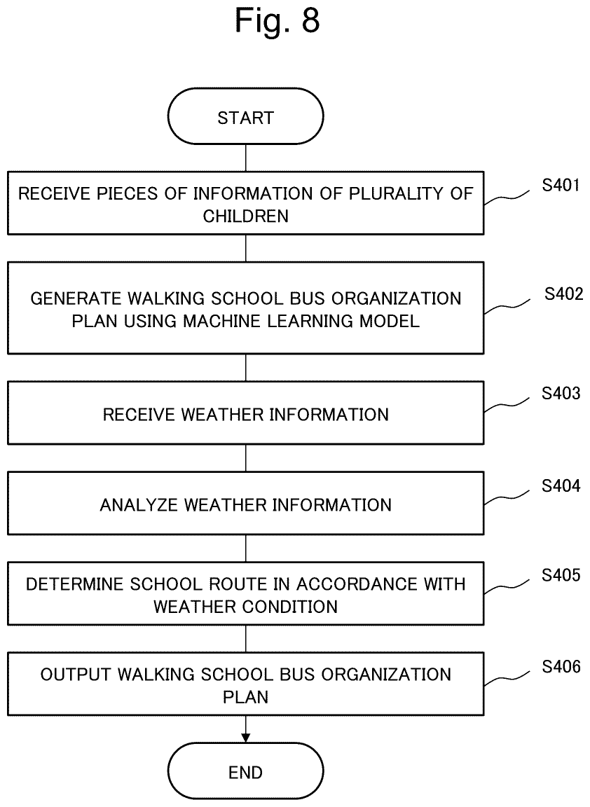

FIG. 8 is a flowchart illustrating the operation of the information processing apparatus according to the present disclosure. An operation example of the information processing apparatus according to the fourth example embodiment will be described with reference to FIG. 8. First, the input means 110 receives personal information of the children (step S401). Next, the generation means 120 generates a walking school bus organization plan using the machine learning model based on the received information (step S402).

Subsequently, the input means 110 receives weather data from the weather information API (step S403). Then, the season/weather response function 123 of the generation means 120 analyzes current weather information in cooperation with the weather information API (step S404). In this analysis, pieces of the weather data such as temperature, precipitation, wind speed, and the ultraviolet index are comprehensively evaluated to identify a factor that may affect the safety of a school road.

Next, the generation means 120 determines an optimal school route in accordance with a current weather condition based on the analysis result (step S405). For example, a route with a low risk of water immersion is preferentially selected in rainy weather, and a route where thorough snow removal has been completed is preferentially selected at the time of snowfall. Furthermore, a route with high safety according to a situation is automatically generated, for example, by proposing a route with a low risk of scattered objects at the time of strong wind.

In step S405, for example, the generation means 120 confirms whether the determined route satisfies the constraint conditions of “avoidance of dangerous spots” and the “movement distance”. Specifically, the route is optimized in such a way that the total movement distance is minimized while avoiding a place where a risk level changes depending on a season or weather (for example, a slope that is likely to freeze in winter).

In a case where the constraint conditions are not satisfied, the generation means 120 optimizes the route again. In this process, the machine learning model is used to search for a more appropriate route while referring to past weather data and safety data of the school road.

When the constraint conditions are satisfied or after the re-optimization, the output means 130 displays the generated organization plan and the optimal route based on the weather on the administrator screen (step S406). At the same time, information is also transmitted to the mobile application for guardians and/or children, and the latest school route information is shared by all the persons concerned.

The system periodically updates the weather information, and immediately returns to step S404 when there is a sudden change of weather, and reevaluates the route and makes a change if necessary. This makes it possible to continuously provide a safe school road in response to the latest weather condition at all times.

According to the present example embodiment, the school route can be dynamically adjusted in accordance with a change of a season or weather. This makes it possible to greatly improve the safety of the children. Specifically, it is possible to provide the safe school road optimized for a weather condition at that time, by automatically selecting a route with a low risk of flooding and falling when there is rain or snowfall and proposing a route with a low risk of scattered objects at the time of strong wind. Further, patterns of dangerous spots and optimal routes per season can be learned by long-term accumulation and analysis of weather data, and a route proposal with higher accuracy can be made. With these functions, it is possible to achieve efficient school-commuting while minimizing the risk of an accident of children on their way to and from school.

Furthermore, the present system can monitor weather information in real time and immediately respond to a sudden change of weather. For example, when a heavy rain or a thunderstorm suddenly occurs, it is possible to immediately propose a safe waiting place or an alternative route and notify the children and/or guardians, and the teachers of the proposal. As a result, even in an unexpected situation, a quick and appropriate response can be taken, the safety of the children can be secured, and the anxiety of the guardians and the teachers can be reduced.

Further, the present system can also respond to fluctuations in sunshine hours accompanying the change of the season, and can optimize group organization and a meeting time in such a way that the children can go to school in a bright time slot. This makes it possible to avoid school-commuting at twilight or at night when the risk of traffic accidents and crime increases, and to achieve a safer school-commuting environment.

The generation means 120 can generate estimated weather information by combining the weather data acquired last with weather patterns of the same period and the same time in the past. Further, the generation means 120 calculates a confidence level of the estimated weather information, and when the confidence level is equal to or less than a certain value, it is possible to propose a route closer to the safety side (for example, a route with a lower risk level than usual).

As a result, even when communication with the weather information API is interrupted or data acquisition fails, it is possible to continue to propose a route in consideration of weather with a certain degree of accuracy. Furthermore, in a case where the confidence level of the estimated weather information is low, it is possible to secure the safety of the children by proposing a route that places more emphasis on the safety.

Furthermore, the generation means 120 can utilize the position information of the child received from the dedicated GPS device. In a state of a place (for example, a valley of a high-rise building or an underground passage) where GPS radio waves do not reach, the generation means 120 can estimate a current position of the child based on the last received position information, a scheduled school route, an average walking speed, and the like. Further, the generation means 120 calculates an error range of the estimated position, and when the error is large, a safety check point (for example, a place where a school safety volunteer is arranged) covering a wider range can be dynamically set.

As a result, the position of the child can be continuously grasped with a certain degree of accuracy even in the place where the GPS radio waves do not reach. Furthermore, when the error in the position estimation is large, the safety of the child can be secured by conducting a safety check in a wider range.

Further, the present disclosure can propose the school route based on the weather data such as temperature and precipitation. This makes it possible to accurately grasp the situation even in a state where a local weather phenomenon (for example, torrential rain) occurs. Furthermore, a function of dynamically changing the route in accordance with a snow removal state can also be implemented in a snowy area.

The generation means 120 can complementarily utilize data from a disaster prevention camera or an IoT sensor installed around a school road, and further real-time information such as SNS posts from local residents. Furthermore, the generation means 120 can generate more accurate local weather information after integrating data from these various information sources and evaluating reliability.

As a result, it is possible to more accurately grasp the situation even in a case where a local weather phenomenon occurs, and it is possible to appropriately change the route and take a safety ensuring measure even against a sudden weather change. Furthermore, it is possible to improve fault resistance of the system and the reliability of information by utilizing various information sources.

The input means 110 may use a voice recognition system instead of the web interface as an example. In this case, the administrator or the guardian can input information of the child and a weather condition by voice, and the system can automatically convert the information into text data and process the text data.

Furthermore, the season/weather response function 123 may use a unique weather sensor network installed around the school road instead of analyzing the current weather information in cooperation with the weather information API as an example. As a result, more local and real-time weather data can be acquired, and a highly accurate route proposal can be made.

Furthermore, the present system has a function of adjusting the school route in accordance with the weather condition, but is not limited thereto. For example, other dynamic factors such as traffic volume data and crime statistics may be taken into account. This makes it possible to propose a more comprehensive safety route that responds to not only the weather but also fluctuations in traffic volume and crime risk.

### Fifth Example Embodiment

The present example embodiment relates to an information processing apparatus that periodically optimizes walking school bus organization in accordance with growth of children and a change in a learning situation. In particular, it is characterized in that it has a function of dynamically adjusting group organization in consideration of performance data and a behavioral assessment for each term. With this function, it is possible to appropriately assign a role in accordance with the growth of the children and organize a group with ability balance.

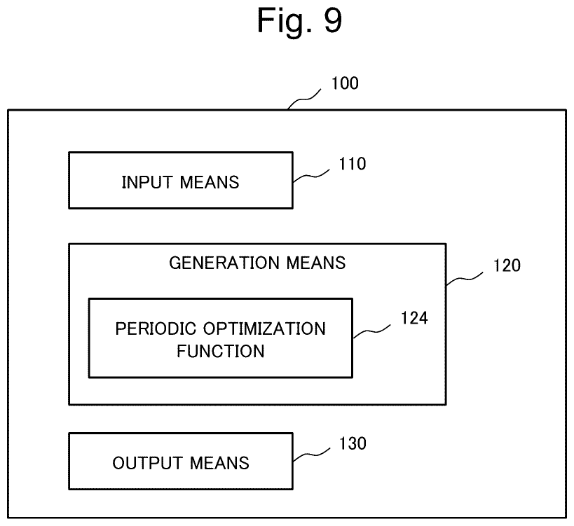

A configuration example of the information processing apparatus 100 according to the present example embodiment will be described with reference to FIG. 9. In the drawing, the information processing apparatus 100 includes an input means 110, a generation means 120, and an output means 130.

The input means 110 has a function of receiving input of personal information and periodic performance/behavioral assessment data of the children through a web interface. Specifically, an administrator can input information such as a name, a grade, an address, personality characteristics, performance data, and a behavioral assessment of the child into a web form. The input means 110 may cooperate with a performance management system of a school or an assessment system for teachers and automatically acquire the performance data and the behavioral assessments of the children. As for the behavioral assessment, assessment items (circles to relevant items) and free comments input by teachers in a dedicated digital form are automatically fetched. This makes it possible to greatly reduce manual input work and always reflect the latest information in a system.

The generation means 120 has a function of generating an optimal walking school bus organization plan based on the input information using a machine learning model. In the present example embodiment, the generation means 120 particularly has a periodic optimization function 124.

The output means 130 has a function of displaying a generated new organization plan on an administrator screen. Specifically, detailed information such as constituent members of each group, a meeting point, a meeting time, and a recommended route is visually displayed.

Next, the operation of the information processing apparatus 100 will be described. First, the input means 110 receives personal information and periodic performance/behavioral assessment data of children. Next, the generation means 120 generates a walking school bus organization plan using the machine learning model based on the received information.

Here, the periodic optimization function 124 of the generation means 120 updates performance data and behavioral assessments of the children for each term. Specifically, the performance data and behavioral assessments input by teachers at the end of each term are automatically fetched, and profiles of the respective children are updated.

Next, the generation means 120 proposes more appropriate group organization again based on the updated data. At this time, “age balance” and “ability” are applied as main constraint conditions. Specifically, academic performance, motor ability, a leadership skill, and the like of each child are comprehensively evaluated, and a group is organized in such a way that the ability can be balanced in the group. Furthermore, a role (e.g.: a team leader or a sub-team leader) is appropriately assigned in accordance with growth. In the generation means 120, a function of extracting an important keyword or tendency from free comments of the teachers by utilizing a natural language processing technology may be implemented. For example, the growth and a change of the child are quantified from the comments such as “the sense of responsibility has increased” and “the relationship with friends has improved”, and the like, and utilized for optimization of group organization.

Finally, the output means 130 displays the generated new optimized organization plan on the administrator screen. The administrator can confirm this new organization plan and make a manual adjustment if necessary.

The information processing apparatus 100 can change the group organization based on a result of a periodic test or assessments of the teachers. For example, the degree of growth of each child is analyzed every end of each term, and a group is reorganized in such a way as to optimize the ability balance. Furthermore, when a bullying problem is reported, a group including relevant children is immediately changed to prevent the problem from expanding. Further, flexible adjustment is performed by moving a child whose motor ability has been improved to a group requiring support or the like.

As described above, the information processing apparatus 100 has a function of periodically optimizing the group organization in accordance with the growth of the children and the change in the learning situation. This makes it possible to respond to the growth of the children and the change in the learning situation, which cannot be handled by the fixed group organization, and to achieve more effective school-commuting in groups.

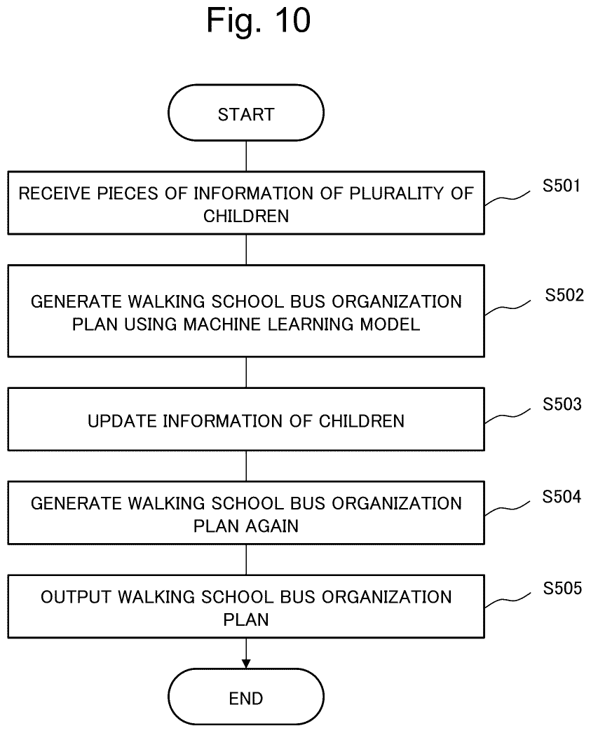

FIG. 10 is a flowchart illustrating an operation example of the information processing apparatus 100. Hereinafter, the operation example of the information processing apparatus 100 will be described in detail with reference to FIG. 10.

First, the input means 110 receives personal information and periodic performance/behavioral assessment data of the children (step S501). Specifically, the administrator inputs performance data at the end of each term and behavioral assessments from the teachers through the web interface in addition to basic information such as names, grades, addresses, and personality characteristics of the children.

Next, the generation means 120 generates a walking school bus organization plan using the machine learning model based on the received information (step S502). At this time, the generation means 120 performs optimal group organization while considering constraint conditions such as age balance and ability.

Subsequently, the periodic optimization function 124 of the generation means 120 updates the performance data and the behavioral assessments of the children for each term (step S503). For example, performance data and behavioral assessments newly input at the end of each term are automatically fetched, and profiles of the respective children are updated. This update is programmed to be automatically performed every term.

Based on the updated data, the generation means 120 proposes more appropriate group organization again (step S504). In this re-proposal, the updated performance data and behavioral assessments are reflected, and an adjustment is made in such a way as to optimize the ability balance in each group. For example, a child with improved performance is moved to a group requiring more advanced support, or a child with improved leadership skill is appointed as a team leader.

Finally, the output means 130 displays a generated new optimized organization plan on the administrator screen (step S505). Information to be displayed includes constituent members of each group, a newly assigned role, a recommended meeting point and time, and the like.

The administrator can confirm the displayed new organization plan and make a manual adjustment if necessary. For example, it is possible to finely adjust an arrangement of a child requiring special consideration or reflect a request from a guardian.

The information processing apparatus 100 can always maintain the optimal walking school bus organization by repeatedly executing the above steps periodically (for example, every term). This makes it possible to flexibly respond to the growth of the children and the change in the learning situation and to achieve more effective and safe school-commuting in groups.

According to the information processing apparatus 100, the group organization can be optimized periodically in accordance with the growth of the children and the change in the learning situation. As a result, the following effects can be obtained.

First, it is possible to perform group organization appropriately responding to the growth of the children and the change in the learning situation. In the fixed group organization, the same organization is often maintained even when a term or a grade changes, and it is difficult to respond to the growth and a change in ability of each child. In the present example embodiment, since the performance data and the behavioral assessments of the children are periodically updated and the group organization is optimized based on the update, it is possible to achieve the organization constantly adapted to the current situation of the children.

Next, the ability balance in each group can be kept in an optimal state. The generation means 120 makes an adjustment to optimize the ability balance in each group based on the updated performance data and behavioral assessments. This makes it possible to continuously provide an environment in which a child with high ability and a child who needs assistance can learn from each other and help each other without being biased to a specific group.

Further, it is possible to appropriately assign a role in accordance with the growth of each child. For example, it is possible to achieve organization that maximizes the ability of each child by appointing a child with improved leadership skill as a team leader or moving a child with improved performance to a group requiring more advanced support. This also leads to development of the self-efficacy and the sense of responsibility of the children.

In addition, it is possible to quickly respond to a sudden situation such as a bullying problem. Although it is difficult to immediately cope with a problem even if the problem occurs in the fixed group organization, in the present example embodiment, it is possible to change a group including related children if necessary to prevent the problem from expanding.

As described above, the information processing apparatus 100 can flexibly respond to the growth of the children and the change in the learning situation, and can always maintain the optimal group organization. This makes it possible to achieve more effective and safe school-commuting in groups and contribute to sound growth of the children and improvement of a learning environment.

The generation means 120 optimizes the group organization based on the performance data and the behavioral assessments of the children. There may be a period during which the periodic update of performance data and behavioral assessments is not performed due to a long vacation, a school event, or the like. In such a case, there is a possibility that it is difficult to appropriately organize groups reflecting the latest situations of the children.

The generation means 120 can adjust the group organization using qualitative evaluation information from a guardian or a teacher. Specifically, during the long vacation or the school event, the guardian or the teacher can input information regarding a recent situation and growth of each child through a dedicated app. The generation means 120 analyzes these pieces of qualitative information, converts the pieces of qualitative information into quantified evaluation indices, and uses the indices for the optimization of group organization.

For example, when a child participates in a volunteer activity during a summer vacation, a guardian reports the content of the activity and a state of the child. The generation means 120 updates an assessment of the leadership and cooperative spirit of the child based on this information and reflects the updated assessment in the group organization. This makes it possible to optimize the group organization in consideration of the growth and change of the child even in a period in which the periodic performance data and behavioral assessment cannot be obtained.

Furthermore, the generation means 120 can construct a prediction model of performance and a behavior in consideration of the past data trend or a seasonal factor, and complement a temporary data shortage. For example, performance change patterns before and after the past long vacations are analyzed, and predicted performance during the current vacation is calculated and reflected in the group organization.

Further, the generation means 120 can adjust the group organization in consideration of a change in an activity amount and life rhythm of each child. During a long vacation, there is a possibility that the life rhythm of the child greatly changes. Therefore, pieces of data of the activity amount and a sleep pattern of the child are collected in cooperation with a wearable device such as a smart watch. The generation means 120 analyzes these pieces of data and reflects the result in the group organization after the vacation. For example, a child whose activity amount is greatly reduced is organized into the same group as a more active child in such a way as to have a good influence on each other.

As described above, even in the period in which the periodic performance data and behavioral assessment cannot be obtained, the generation means 120 can always maintain the optimal group organization by utilizing an alternative information source and the prediction model. This makes it possible to minimize an influence of the temporary data shortage due to a long vacation, a school event, or the like, and to achieve effective school-commuting in groups that appropriately responds to the growth and the changes of the children.

The periodic optimization function 124 may make more frequent updates, such as monthly or weekly, instead of a term-by-term update. Furthermore, the optimization may be performed according to a flexible schedule such as updating before and after a specific event (e.g.: a field day or a school festival).

The “age balance” and the “ability” applied as the constraint conditions can be replaced with other factors such as “personality compatibility” and a “school-commuting distance”. Furthermore, weighting of these constraint conditions may be dynamically changed.

Assessments from the guardians or local volunteers may be used instead of the performance data and behavioral assessments of the children. This makes it possible to perform the group organization in consideration of the growth and changes of the children outside school.

In the present example embodiment, the walking school bus organization is targeted, but this method can also be applied to formation of other groups such as organization of an after-school activity group and organization of classes.

### Sixth Example Embodiment

The present example embodiment relates to an information processing apparatus that dynamically optimizes walking school bus organization and a school road of elementary school students in consideration of an event and construction information of an area. In particular, it is characterized in that it has a function of automatically generating and proposing a temporary route change. With this function, it is possible to flexibly respond to a temporal situation change such as a local festival or road construction and to always secure a safe and efficient school road.

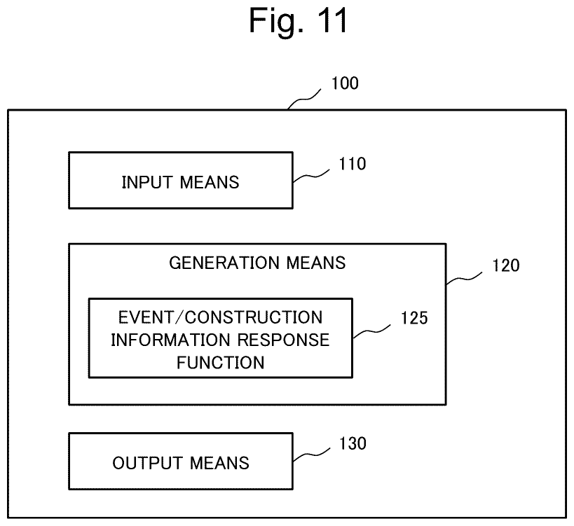

A functional configuration example of the information processing apparatus 100 according to a sixth example embodiment will be described with reference to FIG. 11. In the drawing, the information processing apparatus 100 includes an input means 110, a generation means 120, and an output means 130. The generation means 120 has an event/construction information response function 125. The input means 110 has a function of inputting personal information of children and event/construction information through a web interface. Specifically, an administrator accesses a dedicated web page, and inputs the personal information such as a name, a grade, an address, and personality characteristics of each of the children, and information such as a schedule, a place, and a scale of an event and/or construction scheduled in the area.

The generation means 120 has a function of generating an optimal walking school bus organization plan based on the input information using a machine learning model. In the present example embodiment, the generation means 120 particularly has the event/construction information response function 125. The event/construction information response function 125 automatically calculates and proposes a temporary detour by inputting the local festival and the construction information to a system.

The output means 130 has a function of displaying a generated changed route on an administrator screen. Specifically, a normal route and the changed route are displayed on a map, and a changed spot is highlighted. Furthermore, additional information such as a reason for the change and a period is also displayed.

The generation means 120 applies, for example, a “movement distance” and “avoidance of dangerous spots” as constraint conditions. Specifically, a route with the minimum total movement distance and the minimum required time is selected in consideration of temporary closure and congestion due to the event and/or construction in the area. Furthermore, safety around a construction site is evaluated, and a detour is set if necessary.

For example, in a case where a summer festival of the area is held, the generation means 120 proposes a route that is detouring as compared to a normal route but is safe in consideration of traffic regulation information around a festival site. At this time, a constraint is set in such a way that the additionally required time does not exceed 10 minutes. Furthermore, in a case where long-term road construction starts, a route is changed stepwise in accordance with the progress of the construction. For example, a partially detouring route is set at the beginning of the construction, and the route is switched to a completely detouring route when the construction is in full scale.

Further, the generation means 120 can change the school route based on an event calendar or a construction schedule of the area. For example, when a local festival is held, a route avoiding a district where congestion is expected is automatically set. Furthermore, road closure information due to a sudden accident or a disaster is immediately reflected, and a safe alternative route is proposed.

Specifically, the generation means 120 performs the following operation. The input means 110 receives personal information of children and event/construction information. The generation means 120 generates a walking school bus organization plan using the machine learning model based on the received information. The event/construction information response function 125 of the generation means 120 analyzes a local festival and construction information. The generation means 120 automatically calculates and proposes a temporary detour based on the analysis result. The output means 130 displays the generated organization plan and a temporary changed route on the administrator screen.

According to the information processing apparatus 100, it is possible to propose a school road in which an event or construction information of the area is quickly and appropriately reflected, and it is possible to achieve both safety of the children and efficient school-commuting.

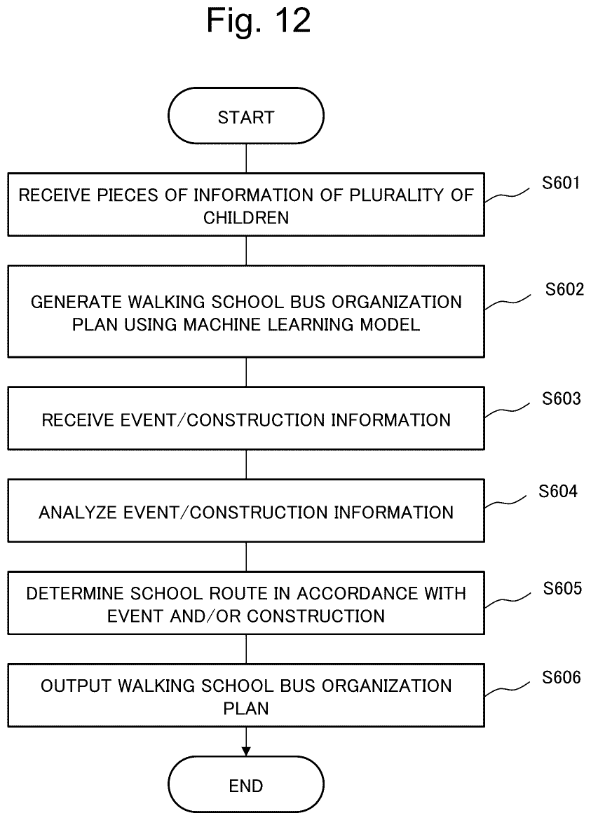

An operation example of the information processing apparatus 100 according to the present example embodiment will be described with reference to FIG. 12. FIG. 12 is a flowchart illustrating an operation example of the information processing apparatus 100.

First, the input means 110 receives personal information of the children (step S601). Specifically, the administrator inputs the personal information such as a name, a grade, an address, and personality characteristics of each of the children, and information such as a schedule, a place, and a scale of an event and/or construction scheduled in the area through the dedicated web page.

Next, the generation means 120 generates a walking school bus organization plan using the machine learning model based on the received information (step S602). At this time, for example, the generation means 120 applies the “movement distance” and the “avoidance of dangerous spots” as the constraint conditions. A group is organized in such a way as to minimize the total movement distance from home to school of each child, and a route is set in such a way as to avoid a spot determined to be dangerous.

Subsequently, the input means 110 receives event/construction information (step S603). Then, the event/construction information response function 125 of the generation means 120 analyzes a local festival and construction information (step S604). Specifically, a school road that is likely to be affected is identified from the input information on an event and construction, and the degree of influence is evaluated. For example, since congestion is expected around a festival site, processing of estimating the time required to pass through such a district to be 1.5 times the normal time or the like is performed.

Next, the generation means 120 automatically calculates and proposes a temporary detour based on the analysis result (step S605). At this time, a route with the minimum total movement distance and the minimum required time is selected in consideration of closure or congestion due to the event and/or construction. For example, in a case where a summer festival of the area is held, a route that is detouring as compared to a normal route but is safe is proposed in consideration of traffic regulation information around a festival site. However, a constraint is set in such a way that the additionally required time does not exceed 10 minutes.

Finally, the output means 130 displays the generated organization plan and the temporary changed route on the administrator screen (step S606). Specifically, a normal route and the changed route are displayed on a map, and a changed spot is highlighted. Furthermore, additional information such as a reason for the change and a period is also displayed.

Note that the generation means 120 can change the school route based on an event calendar or a construction schedule of the area. For example, in a case where long-term road construction starts, a route is changed stepwise in accordance with the progress of the construction. Specifically, a partially detouring route is set at the beginning of the construction, and the route is switched to a completely detouring route when the construction is in full scale. Furthermore, it is also possible to immediately reflect road closure information due to a sudden accident or a disaster and propose a safe alternative route.

As described above, the information processing apparatus 100 can propose a school road in which an event or construction information of the area is quickly and appropriately reflected, and can achieve both safety of the children and efficient school-commuting.

According to the information processing apparatus 100, it is possible to propose the school road in which the event or the construction information of the area is quickly and appropriately reflected. This makes it possible to achieve both the safety of the children and the efficient school-commuting. Specifically, it is possible to secure a safe school road while reducing a burden on the children by selecting a route that minimizes the total movement distance and the required time in consideration of the temporary closure or the congestion due to the event or the construction. Furthermore, it is possible to quickly and appropriately take a measure even in an emergency by immediately reflecting the road closure information due to the sudden accident or the disaster and proposing the safe alternative route. Further, even for long-term road construction, it is possible to always maintain the optimal school road by changing the route stepwise in accordance with the progress of the construction. As described above, the information processing apparatus 100 can flexibly respond to various changes in situation and can continuously support the safety of the children and the efficient school-commuting.

The generation means 120 automatically calculates and proposes the temporary detour based on the event/construction information. It is possible to acquire real-time traffic information and weather information and to quickly recalculate a route based on these pieces of information. For example, it is possible to immediately reflect information on an accident or a disaster in cooperation with real-time information feed of the police and fire department. Furthermore, it is also possible to analyze information on social media and detect a sudden event in the area.

As a result, even when an unexpected situation occurs, the system can respond quickly and propose a safe alternative route. For example, in a case where a traffic accident occurs on the way to or from school, the system can immediately calculate a safe detour and send information by a push notification to a guardian of a related group or a related person in school.

Furthermore, the generation means 120 applies the “movement distance” and the “avoidance of dangerous spots” as the main constraint conditions. It is possible to perform the optimization in consideration of fairness of a school-commuting time and a distance of each child. Specifically, it is possible to set an objective function that minimizes a standard deviation of the school-commuting times of all the children and to optimize a route based on the objective function. Furthermore, it is also possible to give consideration in such a way that an excessive burden is not applied to a child in a lower grade in consideration of age, physical strength, and the like of each child.

As a result, even in a case where a route change due to an event or construction is necessary, it is possible to prevent an excessive burden from being applied to a specific child and to propose a more fair and sustainable school road. For example, in a case where detouring is required due to long-term road construction, the system can periodically review a route and adjust group organization and the route in such a way that no burden is continuously applied to a certain group or child.

The output means 130 may add a function of directly transmitting a notification to a mobile application for guardians and/or children. As a result, route change information can be transmitted to persons concerned in real time.

Although the “movement distance” and the “avoidance of dangerous spots” have been described as the constraint conditions applied by the generation means 120, a “gradient of a slope”, the “number of traffic lights”, and the like may also be taken into consideration. In particular, these elements may be important in a group including a low-grade child.

The generation means 120 refers to the event calendar of the area, but can be linked with a school event calendar. For example, on an event day such as a school visit or a field day, a special route can be proposed in consideration of the guardian's visit to the school.

Further, in the calculation of the detour proposed by the generation means 120, not only the distance and the time are simply minimized, but also comfort such as the quality of the landscape and the size of the sidewalk can be taken into consideration. This makes it possible to propose a more enjoyable and safe school road for children.

Although the information processing apparatus 100 is implemented as a server system, the idea of edge computing can be adopted to perform some processing by a small device installed at each home or school. As a result, a network delay can be reduced, and a more real-time response can be made.

### Seventh Example Embodiment

The present example embodiment is an information processing apparatus that supports group formation, in which a function of tracking position information of individuals belonging to a group in real time and notifying the information to an administrator is added. With this function, safety of children on their way to and from school is greatly improved, and a quick response in an emergency becomes possible. Further, feedback to a generated group organization plan is possible in a seventh example embodiment.

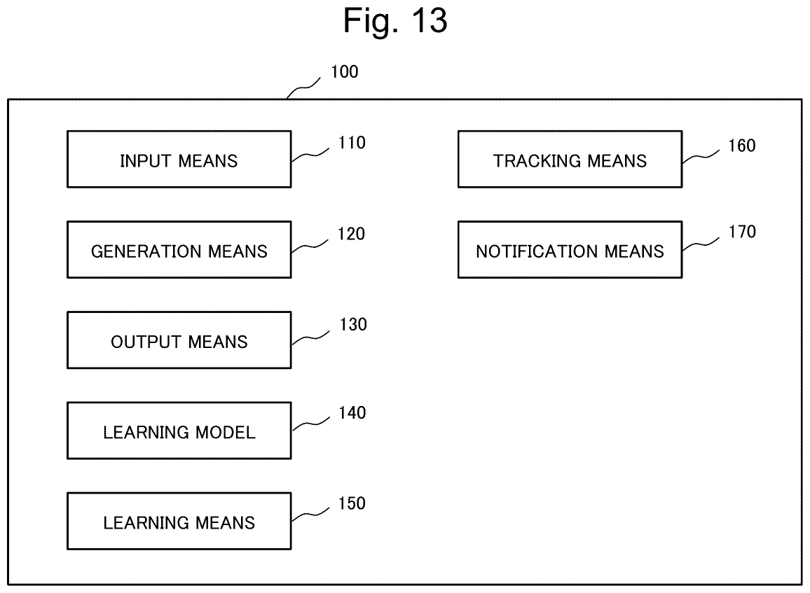

A functional configuration example of the information processing apparatus 100 according to the seventh example embodiment will be described with reference to FIG. 13. In the drawing, the information processing apparatus 100 includes the input means 110, the generation means 120, the output means 130, a learning model 140, a learning means 150, a tracking means 160, and a notification means 170.

The input means 110 receives input of the following information through a web interface or a dedicated application:
Personal information (name, grade, address, personality characteristics, and the like) of each child
Information (contact information, place of employment, possibility of response in an emergency, and the like) of each guardian
Schedules of lesson and extracurricular activity
An event or construction information of an area
A school event calendar
Settings for cooperation with a weather information API
Information regarding dangerous spots on a school road and notes
Feedback information regarding group organization and the school road
Setting information of a global positioning system (GPS) tracking device or a smartphone app

Further, the input means 110 automatically acquires the following information through API cooperation with an external system:
Performance data from a school performance management system
Behavioral assessment data from an assessment system for teachers
Real-time weather data from the weather information API
Road situation data from a traffic information system

The generation means 120 reads map data and dangerous spot information stored in advance. The map data includes a road network around a school, a school road, an intersection, and a position of a traffic light. The dangerous spot information includes a road with a large traffic volume, a place with poor visibility, a place where an accident or a crime has occurred in the past, and the like. The generation means 120 generates an optimal group organization plan using the learning model 140 based on the information stored in advance and the personal information on the children received from the input means 110.

The learning model 140 is a machine learning model for generating a group organization plan. The learning model 140 includes, for example, a neural network using deep learning. Personal information (age, sex, address, personality characteristics, and the like) of each child, geographic information (a home location, a school location, dangerous spots, and the like), and past organization results and feedback information thereof are input to the learning model 140. Then, the learning model 140 outputs an optimal group organization plan.

The learning means 150 is an AI module that collects and analyzes feedback data, and continuously improves the learning model 140 based on information after operation.

The learning means 150 collects feedback information after operation and uses the feedback information as learning data of the learning model 140. For example, problems and improvement requests that have been generated in actual operation are collected, and the model is continuously improved in such a way that a more appropriate plan is generated at the time of the next organization. For example, information on near-misses occurring during actual school-commuting, opinions from guardians, impressions of children, and the like are collected, and the machine learning model is continuously improved based on these pieces of data. For example, evaluations such as “Four-person organization on a rainy day was appropriate” and “Rest points as heat stroke measures were effective” are collected from guardians and teachers, and the model is improved in such a way that a better proposal can be made at the time of the next organization.

The feedback information may be collected at the time of coming home from school, or may be collected in a periodic questionnaire form. Specifically, the following feedback information is collected and analyzed:
Problems and improvements in actual group action
Opinions and requests from guardians and children
A frequency and influence of a schedule change of a lesson or an extracurricular activity
A change in a movement time due to a season or weather
Influence of a change in group organization on child's sociality and motivation for learning

The machine learning model 140 is continuously improved based on these pieces of feedback information to enable generation of a more effective group organization plan. For example, when a specific combination is evaluated well, the feature thereof is learned, and a combination in which a problem occurs is learned to be avoided.

Furthermore, the learning means 150 also fetches a final selection result of an administrator as learning data, and improves the learning model 140 in such a way that a solution can be generated in consideration of the determination tendency of the administrator in the future.

The tracking means 160 cooperates with a GPS tracking device or a smartphone app possessed by each child to acquire position information of the child in real time. Specifically, it has the following functions:

Periodic update of position information: Position information of each child is updated every minute and transmitted to a server.

Detection of route deviation: An alert is issued when a deviation equal to or more than 50 m from a planned route occurs.

Monitoring of moving speed: The moving speed of the child is continuously calculated, and an abnormal speed change (extreme deceleration or acceleration) is detected.

Detection of long-time stop: A case where the child is stopped at the same place for equal to or more than 5 minutes is detected.

Analysis of group action: Pieces of position information of a plurality of children are compared to detect unscheduled gathering or dispersion.

Battery management: The remaining battery level of the device is monitored to issue a warning in case of the low battery.

Privacy protection: Functions in consideration of privacy, such as encryption of position information and stop of tracking outside school hours, are implemented.

Emergency button function: A button that allows the child to easily request assistance in an emergency is provided.

The notification means 170 includes a push notification system and an SMS transmission module, and immediately notifies the administrator (a school staff or a guardian) of the position information and the warning received from the tracking means 160. For example, the summary of the position information is usually notified every 10 minutes, but the immediate notification is made in the following cases:
A case where the child deviates from a scheduled route by equal to or more than 50 m
A case where the moving speed of the child is less than 50% or is more than 200% of the normal walking speed (4 km/h)
A case where the child stops for equal to or more than 5 minutes
A case where a plurality of children gather at an unscheduled place

These notifications are transmitted as push notifications to a smartphone of the administrator, and are also displayed on a management system of a school. In the case of a highly urgent notification, an SMS is also used in combination to reliably transmit the notification to the administrator.

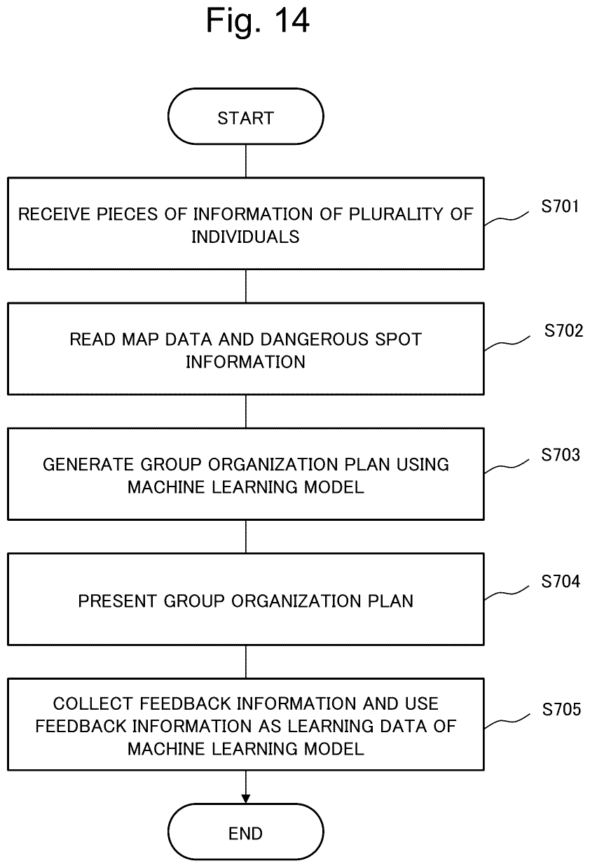

An operation example of the information processing apparatus 100 will be described with reference to the flowchart of FIG. 14.

First, in step S701, the input means 110 receives pieces of information of a plurality of individuals (children) from the administrator. Specifically, the name, grade, sex, address, personality characteristics, special consideration items (e.g.: allergy information and presence or absence of disability), and the like of each child are received.

Next, in step S702, the generation means 120 reads map data of an area and dangerous spot information. These pieces of information are stored in advance in a large-capacity SSD or a cloud storage, and are updated if necessary. The dangerous spot information includes a road with a large traffic volume, a place where an accident or a crime has occurred in the past, and the like.

Subsequently, in step S703, the generation means 120 generates an optimal group organization plan based on pieces of the information of the individuals received by the input means 110 and information stored in a storage means, using the machine learning model. At this time, the generation means 120 considers age balance, personality compatibility, a movement distance, avoidance of dangerous spots, a meeting time, and the like as constraint conditions.

Next, in step S704, the output means 130 presents a group organization plan generated by the generation means 120.

In step S705, the learning means 150 collects feedback information after operation and uses the feedback information as learning data of the machine learning model. The collected information includes a difference between an actual meeting time and the scheduled time, a frequency of route deviation, an evaluation from a guardian, and the like.

According to the seventh example embodiment, the machine learning model 140 can be continuously updated based on actual school-commuting data and feedback. For example, it is possible to cause a child to have a GPS-function-equipped device for school-commuting and collect data of an actual school route and a required time. Furthermore, it is also possible to periodically collect feedback from a guardian or a teacher and utilize these pieces of information as learning data of the machine learning model.

The continuous learning utilizing the feedback information improves the accuracy of a system over time. When knowledge obtained during actual operation is reflected in the machine learning model, it is possible to perform optimal group organization more adapted to the actual situation of the area.

The learning means 150 may be the AI module that collects and analyzes the feedback data, or may be a data mining system using a statistical method. Furthermore, a knowledge-based system incorporating knowledge of experts may be used. Further, a complex learning system in which these are combined may be used. The collection of the feedback information by the learning means 150 may utilize vital data from a wearable device or information from an Internet of Things (IoT) sensor installed in a town, in addition to the input through the questionnaire or the application.

In the present example embodiment, the tracking means 160 acquires the position information of each child using the GPS tracking device or the smartphone app, but the present disclosure is not limited thereto. For example, the tracking means 160 may be used instead of a position detection system using a radio frequency identification (RFID) tag or a system in which a security camera installed on a street and an image recognition technology are combined.

Although an example in which the information processing apparatus according to the present disclosure is applied to the educational field has been described in each of the example embodiments, the example to which the present disclosure is applied is not limited thereto. The present disclosure can be applied not only to the educational field but also to various fields such as welfare for the elderly, corporate human resources, and sports team management. Furthermore, the present disclosure is not limited to organization of a group moving on foot, and can be applied to organization of a group moving by car sharing. At this time, the input means 110 acquires information such as “occurrence of a traffic jam due to a vehicle accident at an ∘∘ intersection” from a traffic information system API. Then, the generation means 120 reflects the information on the traffic jam in real time and adjusts a route in such a way as to minimize a required time. If necessary, a change of a meeting time or a meeting point is also proposed.

### (Hardware Configuration)

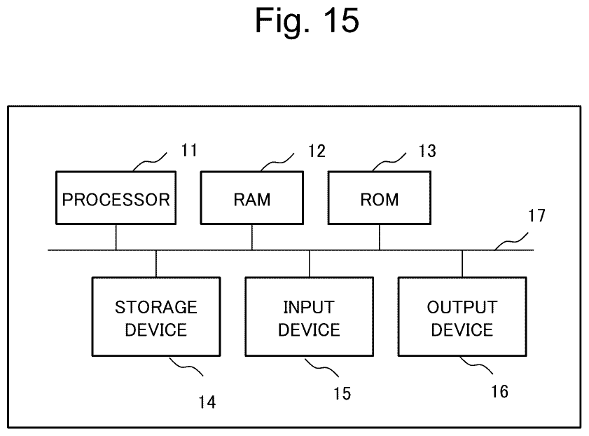

A hardware configuration example of the information processing apparatus according to the present disclosure will be described with reference to FIG. 15. FIG. 15 is a block diagram illustrating the hardware configuration example of the information processing apparatus according to the present disclosure.

As illustrated in FIG. 15, the information processing apparatus includes a processor 11, a random access memory (RAM) 12, a read only memory (ROM) 13, a storage device 14, an input device 15, and an output device 16. The processor 11, the RAM 12, the ROM 13, the storage device 14, the input device 15, and the output device 16 described above are connected via a data bus 17. Note that the data bus 17 may be an interface (for example, a LAN, a USB, or the like) other than a data bus.

The processor 11 reads a computer program. For example, the processor 11 is configured to read the computer program stored in at least one of the RAM 12, the ROM 13, and the storage device 14. Alternatively, the processor 11 may read the computer program stored in a computer-readable recording medium using a recording medium reading device (not illustrated). The processor 11 may acquire (that is, read) the computer program from a device (not illustrated) arranged outside the information processing apparatus via a network interface. The processor 11 executes various types of processing by executing the read computer program. When the processor 11 executes the read computer program, a functional block related to processing executed by the information processing apparatus is implemented in the processor 11. That is, the processor 11 may function as a controller that executes each control in the information processing apparatus.

The processor 11 may be configured as, for example, a central processing unit (CPU), a graphics processing unit (GPU), a field-programmable gate array (FPGA), a digital signal processor (DSP), an application specific integrated circuit (ASIC), or a quantum processor. The processor 11 may be configured as one of them or may be configured to use a plurality of them in parallel.

The RAM 12 temporarily stores the computer program executed by the processor 11. The RAM 12 temporarily stores data temporarily used by the processor 11 when the processor 11 executes the computer program. The RAM 12 may be, for example, a dynamic random access memory (D-RAM) or a static random access memory (SRAM). Instead of the RAM 12, another type of volatile memory may be used.

The ROM 13 stores the computer program executed by the processor 11. The ROM 13 may store other fixed data. The ROM 13 may be, for example, a programmable read only memory (P-ROM) or an erasable read only memory (EPROM). Instead of the ROM 13, another type of non-volatile memory may be used.

The storage device 14 stores data to be stored for a long period of time by the information processing apparatus. The storage device 14 may operate as a temporary storage device of the processor 11. The storage device 14 may store the computer program executed by the processor 11. The storage device 14 may include, for example, at least one of a hard disk device, a magneto-optical disk device, a solid state drive (SSD), and a disk array device.

The input device 15 is a device that receives an input instruction from a user of the information processing apparatus. The input device 15 may include, for example, at least one of a keyboard, a mouse, a touch panel, and a touch pen. The input device 15 may be, for example, a device capable of voice input including a microphone.

The output device 16 is a device that outputs information regarding the information processing apparatus to the outside. For example, the output device 16 may be a display device (for example, a display, a monitor, or the like) capable of displaying the information regarding the information processing apparatus. Furthermore, the output device 16 may be a speaker or the like capable of outputting the information regarding the information processing apparatus by voice.

Note that the information processing apparatus may be configured to include some of the respective components described in FIG. 15. For example, the information processing apparatus may include only the processor 11, the RAM 12, and the ROM 13 among the above-described components. In this case, each of the storage device 14, the input device 15, and the output device 16 may be provided as a device outside the information processing apparatus. Furthermore, a part of a calculation function in the information processing apparatus may be implemented by an external server, a cloud, or the like.

The present disclosure may be achieved by recording a program for implementing the above-described functions in a computer-readable recording medium, and reading and executing the program recorded in the recording medium in a computer system.

Note that the “computer system” here includes hardware such as an OS and peripheral devices.

The “computer-readable recording medium” refers to a portable medium such as a flexible disk, a magneto-optical disk, a ROM, or a CD-ROM, and a storage device such as a hard disk built in the computer system. Further, the “computer-readable recording medium” may include a medium that dynamically holds a program for a short time, such as a communication line in a case where the program is transmitted via a network such as the Internet or a communication line such as a telephone line, and a medium that holds a program for a certain period of time, such as a volatile memory inside a computer system serving as a server or a client in this case. Further, the program may be configured to implement some of the above-described functions, may be capable of implementing the above-described functions in combination with a program already recorded in a computer system, or may be achieved by using a programmable logic device such as a field programmable gate array (FPGA).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above-described example embodiments may also be described as the following supplementary notes, but are not limited to the following supplementary notes.

### Supplementary Note 1

An information processing apparatus including:
an input means for receiving pieces of information of a plurality of individuals;
a generation means for generating a group organization plan using a machine learning model with at least one of age balance, personality compatibility, a movement distance, avoidance of a dangerous spot, a meeting time, and an ability as a constraint condition based on pieces of the information of the individuals received by the input means; and
an output means for outputting the group organization plan generated by the generation means.

### Supplementary Note 2

The information processing apparatus according to Supplementary Note 1, wherein
the generation means generates the group organization plan combined with a guardian capable of helping school-commuting in consideration of a schedule of the guardian when a walking school bus organization plan for children is generated as the group organization plan.

### Supplementary Note 3

The information processing apparatus according to Supplementary Note 2, wherein
the generation means optimizes the meeting time in consideration of the schedule of the guardian.

### Supplementary Note 4

The information processing apparatus according to any one of Supplementary Notes 1 to 3, wherein
the input means receives schedules of lessons or extracurricular activities of the individuals, and
the generation means generates the group organization plan based on the schedules.

### Supplementary Note 5

The information processing apparatus according to any one of Supplementary Notes 1 to 4, wherein
the generation means evaluates safety of a route and generates a route based on the evaluation.

### Supplementary Note 6

The information processing apparatus according to any one of Supplementary Notes 1 to 5, wherein
the generation means adjusts a route in accordance with a season or weather.

### Supplementary Note 7

The information processing apparatus according to any one of Supplementary Notes 1 to 6, wherein
the generation means changes a route by reflecting an event or construction information of an area.

### Supplementary Note 8

The information processing apparatus according to any one of Supplementary Notes 1 to 7, wherein
the input means receives input of performance data or a behavioral assessment for each term, and
the generation means periodically optimizes the group organization plan based on the performance data or the behavioral assessment.

### Supplementary Note 9

An information processing method including:
receiving pieces of information of a plurality of individuals;
generating a group organization plan using a machine learning model with at least one of age balance, personality compatibility, a movement distance, avoidance of a dangerous spot, a meeting time, and an ability as a constraint condition based on pieces of the information of the individuals; and
outputting the generated group organization plan.

### Supplementary Note 10

A program for causing a computer to execute processing of:
receiving pieces of information of a plurality of individuals;
generating a group organization plan using a machine learning model with at least one of age balance, personality compatibility, a movement distance, avoidance of a dangerous spot, a meeting time, and an ability as a constraint condition based on pieces of the information of the individuals; and
outputting the generated group organization plan.

Some or all of the configurations described in Supplementary Notes 2 to 8 dependent on the above-described Supplementary Note 1 can also be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, and 9 and 10, but also various pieces of hardware and software, and various recording devices or systems for recording software without departing from the above-described example embodiments.

What is claimed is:

1. An information processing apparatus comprising:
at least one memory storing instructions; and
at least one processor configured to execute the instructions to:
receive pieces of information of a plurality of individuals;
generate, based on pieces of the information of the plurality of individuals received, a group organization plan using a machine learning model with at least one of age balance, personality compatibility, a movement distance, avoidance of a dangerous spot, a meeting time, and an ability as a constraint condition; and
output the group organization plan generated.

2. The information processing apparatus according to claim 1, wherein the at least one processor is further configured to execute the instructions to:
generate the group organization plan combined with a guardian capable of helping school-commuting in consideration of a schedule of the guardian when a walking school bus organization plan for children is generated as the group organization plan.

3. The information processing apparatus according to claim 2, wherein the at least one processor is further configured to execute the instructions to:
optimize the meeting time in consideration of the schedule of the guardian.

4. The information processing apparatus according to claim 1, wherein the at least one processor is further configured to execute the instructions to:
receive input of schedules of lessons or extracurricular activities of the individuals, and
generate the group organization plan based on the schedules.

5. The information processing apparatus according to claim 1, wherein the at least one processor is further configured to execute the instructions to:
evaluate safety of a route; and
generate a route based on the evaluation.

6. The information processing apparatus according to claim 1, wherein the at least one processor is further configured to execute the instructions to:
adjust a route in accordance with a season or weather.

7. The information processing apparatus according to claim 1, wherein the at least one processor is further configured to execute the instructions to:
change a route by reflecting an event or construction information of an area.

8. The information processing apparatus according to claim 1, wherein the at least one processor is further configured to execute the instructions to:
receive input of performance data or a behavioral assessment for each term; and
periodically optimize the group organization plan based on the performance data or the behavioral assessment.

9. An information processing method comprising:
receiving pieces of information of a plurality of individuals;
generating, based on pieces of the information of the plurality of individuals, a group organization plan using a machine learning model with at least one of age balance, personality compatibility, a movement distance, avoidance of a dangerous spot, a meeting time, and an ability as a constraint condition; and
outputting the generated group organization plan.

10. A non-transitory computer-readable recording medium storing a program for causing a computer to execute processing of:
receiving pieces of information of a plurality of individuals;
generating, based on pieces of the information of the plurality of individuals, a group organization plan using a machine learning model with at least one of age balance, personality compatibility, a movement distance, avoidance of a dangerous spot, a meeting time, and an ability as a constraint condition; and
outputting the generated group organization plan.
